(19) United States
(12) Patent Application Publication
(10) Pub. No.: US 2026/0138409 A1
(43) Pub. Date: May 21, 2026

(54) HEIGHT-ADJUSTABLE AIR SUSPENSION TRAILER

(71) Applicant: Peter COLLORAFI, Mermaid Waters (AU)

(72) Inventor: Peter COLLORAFI, Mermaid Waters (AU)

(21) Appl. No.: 19/123,033

(22) PCT Filed: Oct. 19, 2023
(86) PCT No.: PCT/AU2023/051042

§ 371 Date: Apr. 21, 2025

(30) Foreign Application Priority Data
Oct. 21, 2022 (AU) 2022903112

(51) Int. Cl. B60G 17/015; B60D 1/01; B60D 1/36; B60G 7/00; B60G 7/02; B60G 17/019

(52) U.S. Cl. CPC B60G 17/0155; B60D 1/01; B60D 1/36; B60G 7/001; B60G 7/02; B60G 17/01908; B60G 2200/13; B60G 2202/152; B60G 2206/10; B60G 2300/04; B60G 2500/30

(57) ABSTRACT

A height-adjustable trailer (1000) comprises a chassis (100), drawbar assembly (300) pivotally attached to the chassis (100) and wheel-suspension assemblies (200) mounted to the chassis (100) at sides of the trailer (1000). Each of the wheel-suspension assemblies (200) comprises a chassis airbag assembly (210), a swingarm linkage (220) and a wheel assembly (230). Control system (500) pneumatically controls the chassis airbag assembly (210) and a drawbar airbag assembly (400) which coordinate to raise and lower the chassis (100) as required.

### TECHNICAL FIELD

The present invention concerns trailers of the type used with passenger and light commercial vehicles.

### BACKGROUND OF THE INVENTION

Trailers used with passenger or commercial vehicles are generally loaded using one or two ramps, or a winch or hoist, or using some combination of such techniques.

One application is such trailers is carrying motorcycles, as well as other wheeled vehicles or equipment. As specifically regards motorcycles, a rider may typically use ramps or wheel their motorcycle onto a trailer or indeed straight onto the tub or tray of a utility vehicle as a workaround in the absence of a trailer.

Heavier motorcycles, in particular touring or highly customised motorcycles, such as larger models typically V-twin engine models such as those offered under the Harley-Davidson® brand can be cumbersome to ramp load. This is owing to the weight and bulk of the motorcycle, and also utility ramps used with trailers tend to be reasonably narrow (for example, around 12′ or 300 mm).

As a motorcycle is however not particularly large compared to many loads a high-capacity trailer is not required. Trailers capable of accommodating the weight of such motorcycles do not offer a universally convenient means of loading.

Another alternative for transporting motorcycles is using a carrier fits to a hitch receiver. Such designs typically feature a track in which the bike is stored pivots to double as a ramp for loading. While convenient for lighter motorcycles, the steep loading angle is not suitable for heavier motorcycles, and unsuitable for other applications.

An objective of the present invention is to at least attempt to address one or more of these and other limitations of existing approaches.

### SUMMARY OF INVENTION

The present invention in one embodiment comprises a height-adjustable trailer. The height-adjustable trailer comprises a chassis, a drawbar assembly pivotally attached to the chassis, and wheel-suspension assemblies mounted to the chassis at lateral opposing sides of the trailer.

Each of the wheel-suspension assemblies comprise a chassis airbag assembly, a swingarm linkage, and a wheel assembly. The wheel assembly is mounted on the swingarm linkage. The swingarm linkage is pivotally attached to the chassis. The chassis airbag assembly is pivotally attached at one end to the swingarm linkage. The chassis airbag assembly is pivotally attached at its other end to the swingarm linkage. A drawbar airbag assembly is attached to the chassis and the drawbar assembly.

The height-adjustable trailer further comprises a control system pneumatically attached to the drawbar airbag assembly and the chassis airbag assemblies and configured to extend the chassis airbag assemblies and the drawbar airbag assembly thereby to raise the chassis of the trailer to an operative travel height.

The chassis can thus be raised from a lowered position—in which the chassis essentially rests on the ground together adjacent tyres of the wheel assemblies—to a raised position in which the chassis is preferably about level with a centre of the wheel assemblies, which represents operative travel height.

Each of the swingarm linkages is triangular in form comprising three elongate linkages connected together to define spaced apart junctions between adjacent linkages. The swingarm linkage is preferably connected to the wheel assembly, and the chassis airbag assembly and the chassis at respective different junctions of the swingarm linkage.

The height-adjustable trailer further comprises one or more locking assemblies comprising locking pin actuators and locking pins actuated by the locking pin actuators. The control system is electrically connected to the locking assemblies and when the trailer is in the raised position the locking pins can be retractably extended by the locking pin actuators though adjacent members of the chassis and the drawbar assembly to retain the trailer in the raised position.

The locking pin actuators are electronically actuated by the control system and configured so that the locking pins remain in an extended position in the absence of electrical power to the locking pin actuators.

Control system comprises pneumatic circuitry and components, and electrical circuitry and components. Control system is pneumatically connected to the drawbar airbag assembly and the chassis airbag assemblies and configured to coordinate inflation of the airbag assemblies thereby to raise the chassis to an operative travel height. The chassis is raised relative to the wheel assemblies to a raised position suited to travel. The chassis may be correspondingly lowered to a lowered position by deflating the drawbar airbag and chassis airbags as controlled by the control system.

The swingarm linkages can be broadly characterised as a form of single-sided cantilever swingarm. This arrangement permits the chassis airbags to act on the swingarm linkages, which has the effect of lowering the chassis relative to the wheel assemblies for raising the lowering the chassis in a simple single pivot configuration.

The control system comprises a compressor, air tank and pneumatic circuitry that co-ordinates inflation and deflation of the chassis airbags and drawbar airbag for controlled lowering and raising of the chassis and any load attached thereto.

The control system also co-ordinates operation of a failsafe mechanism in the form of retractable locking pins that extend from the drawbar assembly through the chassis when the trailer is in a raised position. The locking pins are retracted for lowering of the chassis to a lowered position.

The actuation of the drawbar linkage and the swingarm linkage is precisely coordinated by balancing the pneumatic pressure delivered to the chassis airbags and the drawbar airbag.

The chassis features a tray (for example, aluminum checkerplate) and optionally a series of heavy duty eyelets as tie down points for straps for securing a motorcycle or other load. Conveniently there is a wheel receiver in the form of a hockey stick-shaped track for receiving and positioning a front leading wheel of a motorcycle in a locked down position.

Skid plates can be preferably attached to an underside of the chassis, facing the road surface to protect the chassis.

Wheel guards are fitted over the wheels at the stub axles, and a cowling protects the chassis airbags. The trailer is desirably finished in a powder coating to seal from the elements and maintain appearance.

The trailer as described and depicted herein has particular advantages. Advantageously, the use of wheel-suspension assemblies permits raising and lowering the chassis of the trailer while also incorporating an effective suspension for the trailer, which avoids engineering a separate suspension means in the trailer.

The swingarm linkage arrangement described herein provides stability and safety, and especially when combined with the inherent structural strength of a triangular linkage. A simple triangular form geometry for the swingarm linkage is a simple solution that avoids unnecessary fabrication and weight.

The chassis airbag assemblies are designed for safety owing to the incorporation of a rigid hydraulic strut, which is actuated though inflation or deflation of chassis airbags disposed around and acting upon the hydraulic strut is particularly advantageous. A hydraulic strut offers suitable damping characteristics under extension and contraction of the airbags. This also avoids the need for separate suspension mechanisms.

Arrangements in which airbags are unsupported may suffer deformation during use, which reflects and exacerbates structural stresses in other components. This can lead to failure of the airbags and related components.

Locking assemblies of the type described ensure a safety locking mechanism, and its failsafe locking feature offer particular advantages in the event of any failure associated with the airbag assemblies or electrical system, ensuring the trailer when in motion will stay at its operative travel height and permit mitigating action to be taken without incident.

Control system is advantageously arranged to avoid unnecessary complexity by simple coordination between drawbar airbag and chassis airbags when raising the chassis, and permitting lowering of the chassis by straightforward deflation of the airbags as described herein.

The height-adjustable trailer described has various other advantages as will be apparent to those skilled in the art.

### BRIEF DESCRIPTION OF DRAWINGS

FIGS. 1-4 depict a trailer constructed in according to embodiments described herein. FIGS. 1 and 2 depict the trailer from a rear offset perspective and in a lowered position in a single carrier variant (FIG. 1) and a dual carrier variant (FIG. 2). FIGS. 3 and 4 depict the trailer in similar rear offset perspective views of FIGS. 1 and 2, though in a raised rather than lowered position, again in a single carrier variant (FIG. 3) and a dual carrier variant (FIG. 4).

FIGS. 5 and 6 depict a single carrier variant of the trailer of FIGS. 1 and 3 from a front offset perspective in a lowered position (FIG. 5) and in a raised position (FIG. 6).

FIGS. 7 and 8 depict in plan the single carrier variant (FIG. 7) of the trailer of FIGS. 1 and 3 and the dual carrier variant (FIG. 8) of the trailer in FIGS. 2 and 4.

FIGS. 9 and 10 depict in elevation the single carrier variant of the trailer of FIGS. 1 and 3 in the lowered position (FIG. 9) and in the raised position (FIG. 10).

FIGS. 11 and 12 represent a detail of the trailer of FIGS. 1-10 focusing on the wheel-suspension assembly where it attaches to a chassis assembly of the trailer, in a lowered position (FIG. 11) and in a raised position (FIG. 12).

FIGS. 13 and 14 represent a detail of the trailer of FIGS. 1-10 focusing on a drawbar assembly where attached to the chassis assembly when the trailer is in a raised position, with locking pins engaged (FIG. 14) and locking pins disengaged (FIG. 15).

FIG. 15 depicts in schematic form details of control system used in conjunction with specific assemblies of the trailer to actuate the trailer between lowered and raised positions.

### DETAILED DESCRIPTION OF PREFERRED EMBODIMENTS

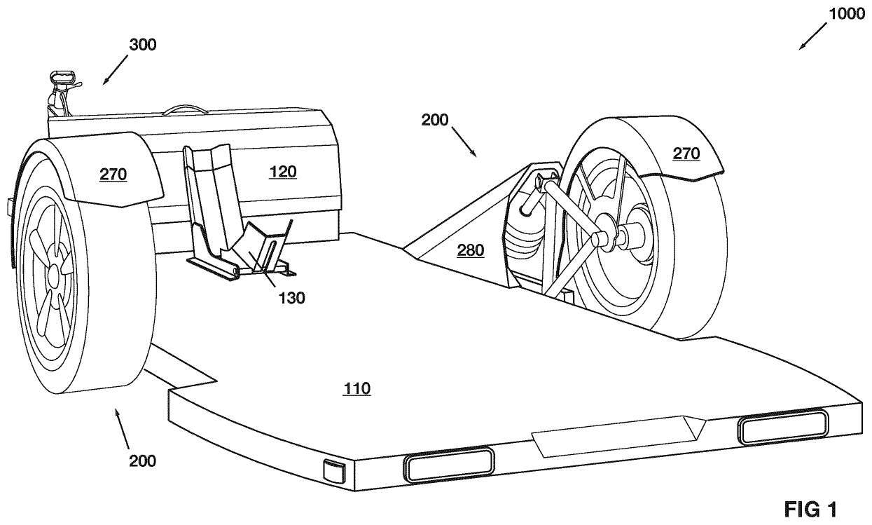

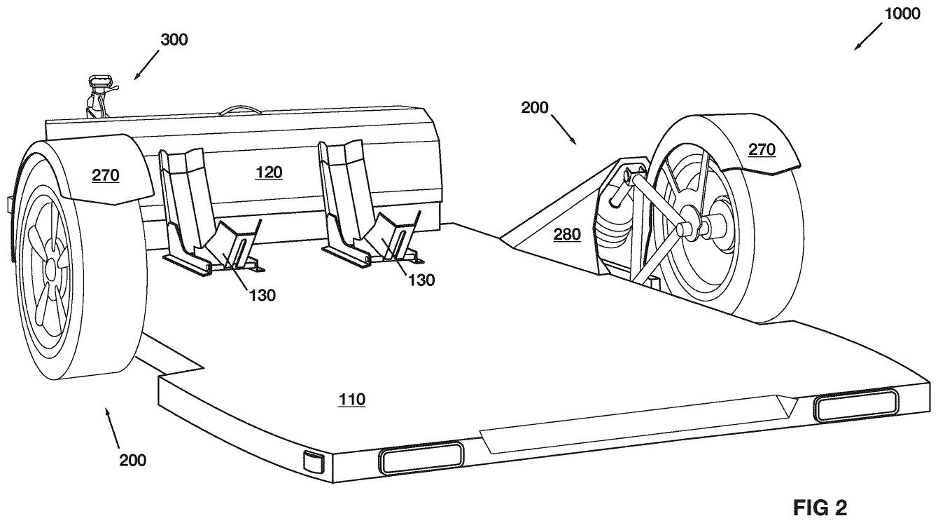

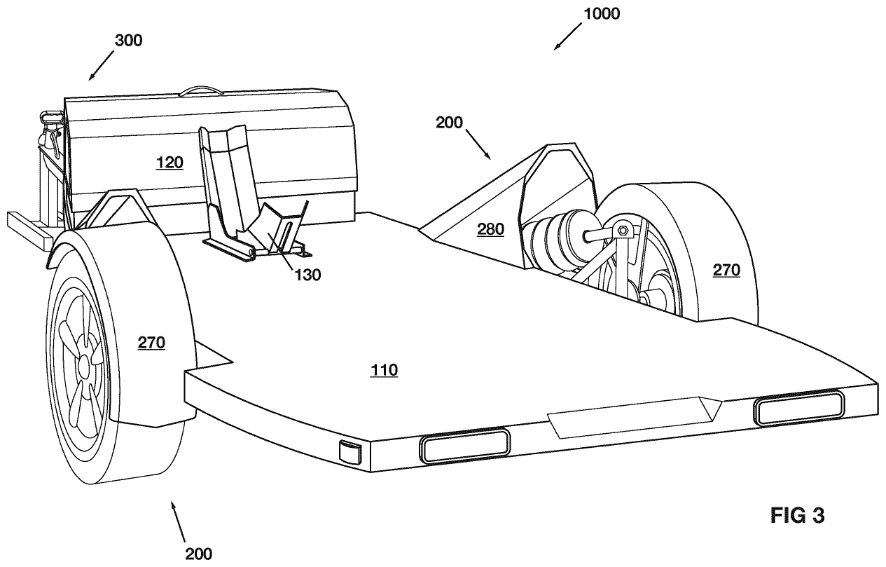

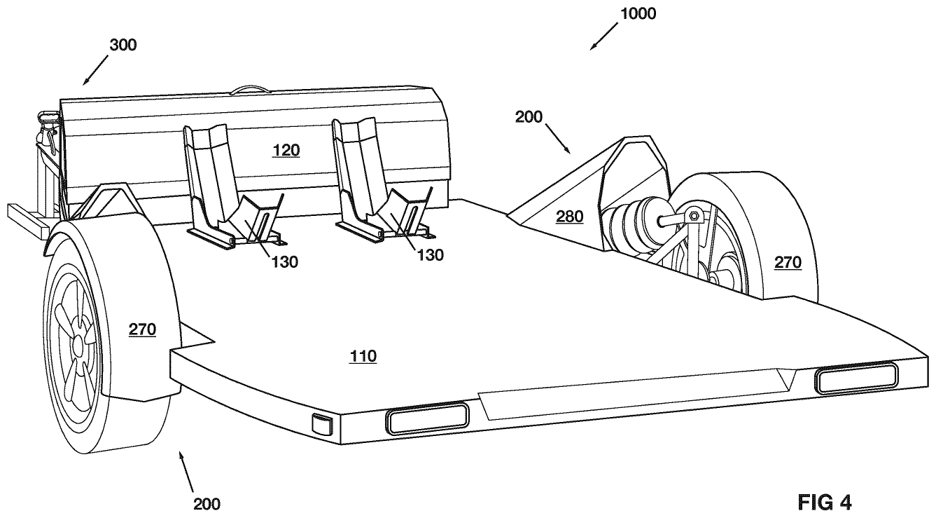

A trailer 1000 according to a preferred embodiment of the present invention is depicted in FIGS. 1-4. Two variants are presented, namely a single carrier variant of FIG. 1 and FIG. 3, and a dual carrier variant of FIG. 2 and FIG. 4. The single carrier variant is characterised by having a single wheel receiver 130, which the dual carrier variant is characterised by having two wheel receivers 130 arranged towards a front leading end of the trailer 1000 laterally aligned to each other in spaced apart relation.

The trailer 1000 presented comprises a chassis 100, and wheel-suspension assemblies 200 fitted to the chassis 100 on opposing lateral sides of the chassis 100. The trailer 1000 further comprises a drawbar assembly 300 pivotally attached to the chassis 100 at a front leading end of the trailer 1000.

The trailer 1000 and chassis 100 is characterised as generally longitudinal in shape and defined by the aforementioned opposed lateral sides and opposed longitudinal ends.

One opposed longitudinal end is referred to as the front leading end of trailer 1000 to indicate the usual forward direction of motion of the trailer 1000 when towed by a towing vehicle (not shown). The front leading end of the trailer 1000 is distinguished from its opposing longitudinal end which is referred to as the rear trailing end of trailer 1000.

The chassis 100 comprises a fabricated grid of steel tubing (preferably of square profile) welded in a pattern designed to supply sufficient structural integrity and carrying capacity for the intended application. The chassis 100 is topped by a tray 110, which is securely attached to the chassis and advantageously has formed thereon a checkerplate pattern. This checkeplate pattern is anti-slip and provides a rugged finish.

Towards the front leading end of the chassis 100 adjacent the drawbar assembly 300, there is mounted upon the tray 110 a component box 120—details of which are described in further detail below.

As a matter of preference one or two wheel receivers 130 are mounted upon the tray 110 beside the component box 120.

Wheel receivers 130 are described in further detail below, as are some other constructional differences of a minor nature between the variant designs of the trailer 1000. Features and construction of the trailer 1000 is largely otherwise commonly shared by these variants as now described.

Wheel receivers 130 generally comprise a hockey stick-shaped channel for receiving and locating the front wheel of a motorcycle (not shown) operatively carried upon the trailer 1000. Wheel receivers 130 are generally of familiar construction and comprises a taller portion of channel that receives an upstanding portion of a motorcycle tyre, and a shorter portion of the channel that is pivotally attached to the rest of the wheel receiver 130. A latching mechanism releases this lower portion so that the leading wheel of the motorcycle can be readily wheeled into the wheel receiver 130. As the leading front wheel of a motorcycle wheel is manoeuvred into the wheel receiver 130, its weight and movement pivots the shorter portion to its usual upstanding position depicted in which it can be securely latched in place. A motorcycle can then also be tied down to the trailer 1000 whilst fitted to the wheel receiver 130 and thus secured for transport upon the trailer 1000. Various other types and designs for securing a motorcycle can be used, in conjunction with other tie-down arrangements according to preference and requirements.

As is evident, the trailer 1000 is dimensioned to permit carrying of one or two motorcycles. Single carrier variants of FIG. 1 and FIG. 3 have one wheel receiver 130 and are narrower laterally across the chassis 100 and tray 110 than the dual carrier variants of FIG. 2 and FIG. 4 as depicted. This permits for easy loading and unloading of motorcycles by providing sufficient room for the motorcycles themselves as well as for riders to negotiate around the tray 110 and the motorcycles. The extra width of dual carrier variant requires only minor modification to chassis 1000 and related components. Even two large motorcycles are not especially heavy and the construction of the chassis 100 can be easily designed to accommodate greater than expected maximal loading to meet engineering and safety requirements. The dimensions and design of the drawbar assembly 300 is also modified slightly to match the chassis 100, as can be appreciated. Other details between variants are shared or modified slightly as required.

Tray 110 may be provided with integral ratchet straps (not shown), or eyebolts (not shown) or other means to secure motorcycle or other load using strapping or similar arrangements to assist with tying down of motorcycles or other equipment to be carried by trailer 1000.

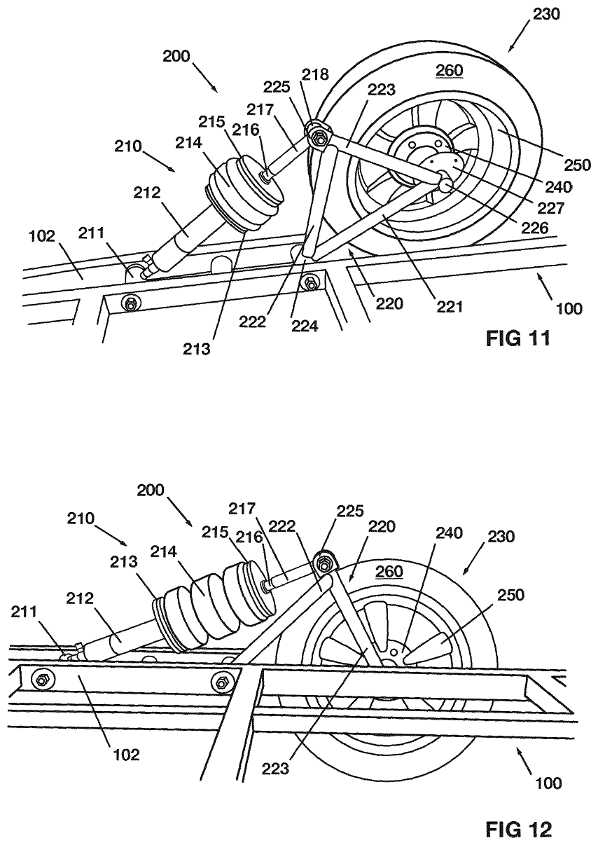

As is evident, the trailer 1000 of FIG. 1 and FIG. 2 are in a lowered position, and the trailer 1000 of FIG. 3 and FIG. 4 are in a raised position. The wheel-suspension assemblies 200 attached at laterals sides of the trailer 1000 to the chassis 100 operate to raise and lower the trailer 1000 in cooperation with control system 500 housed within the component box 120, as described in further detail below. Wheels guards 270 and chassis airbag cowlings 280 are also apparent in these drawings, which form part of the wheel-suspension assemblies 200, which are described in further detail below in conjunction with FIGS. 11-12.

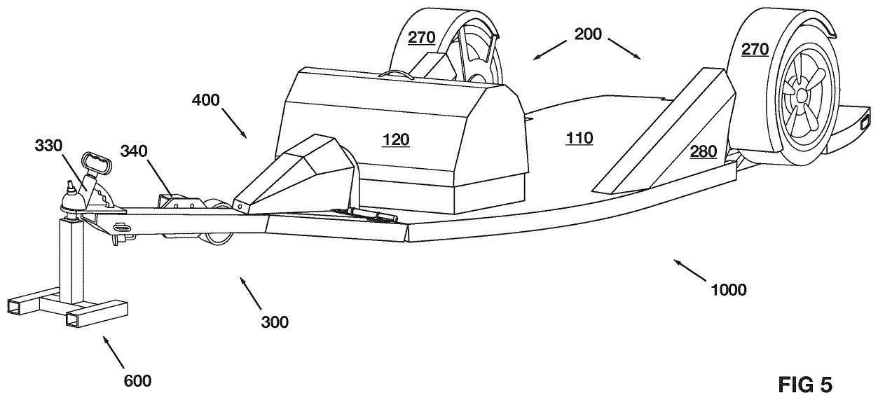

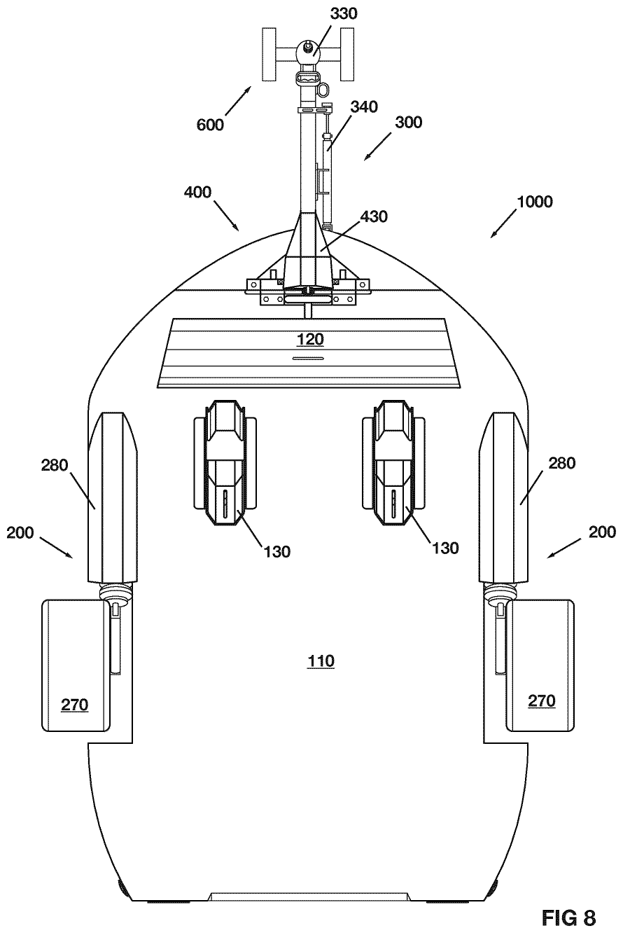

FIGS. 5-14 present other views of the trailer 1000 in lowered or raised positions, principally for the single carrier variant, with the exception of FIG. 8 which depicts the dual carrier variant. Similar considerations apply for the dual carrier variant as the single carrier variant as already noted.

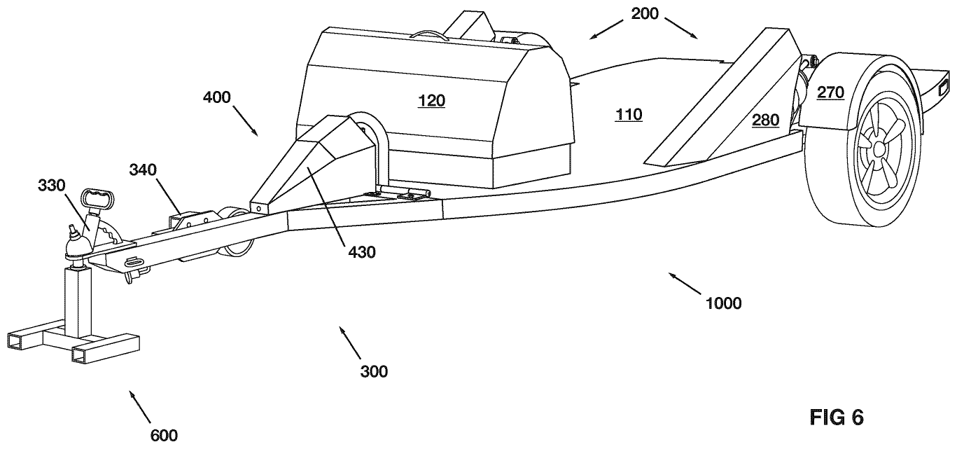

FIGS. 5 and 6 present the trailer 1000 as viewed from a front offset perspective which permits an unobstructed view of drawbar assembly 300 in greater detail than FIGS. 1-4. Tow hitch 330 and a jockey wheel assembly 340, both of conventional construction, form part of the drawbar assembly 300. Tow hitch 330 is supported by a stand 600, which does not form part of the trailer 1000. Stand 600 is however included and most evident in FIGS. 5-10 to convey operation of the trailer 1000 when in lowered and raised positions. This is most clearly evident in FIGS. 5 and 6, and FIGS. 9 and 10, which show lowered positions and raised positions in perspective and elevation respectively.

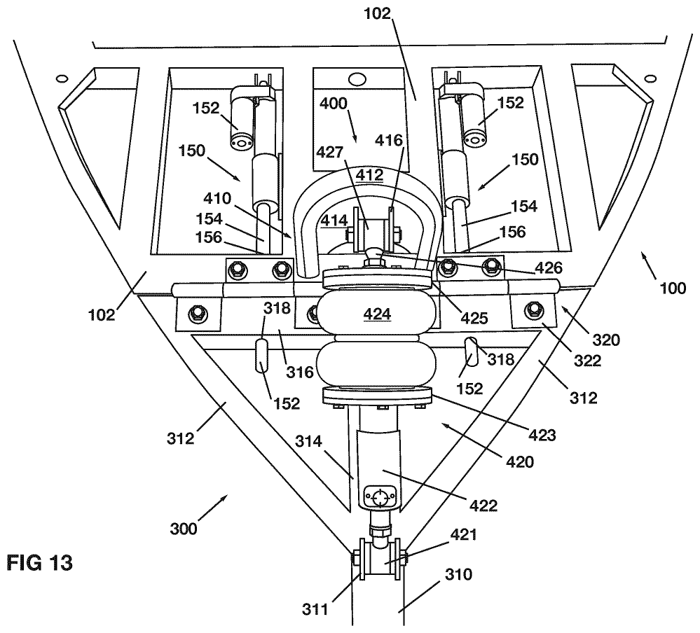

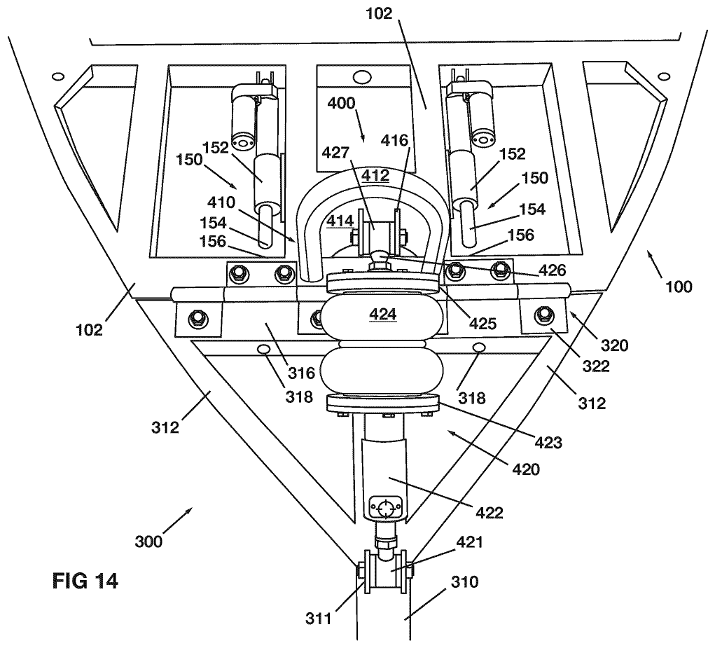

A drawbar airbag assembly 400 mounted upon the drawbar assembly 200 and chassis 100 is also apparent in these drawings, and in particular a drawbar airbag cowling 430 forming part of the drawbar airbag assembly 400 is apparent. The drawbar assembly 300 and drawbar airbag assembly 400 are described in further detail below in conjunction with FIGS. 13-14.

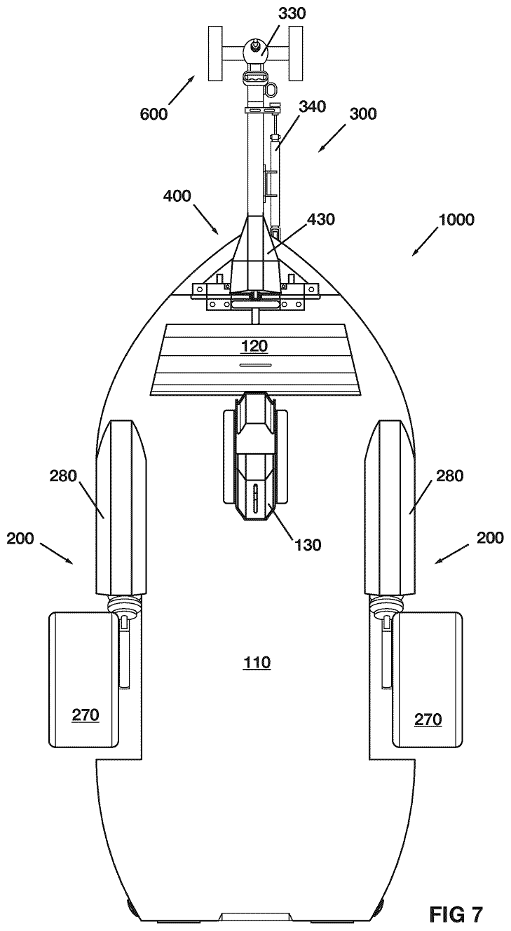

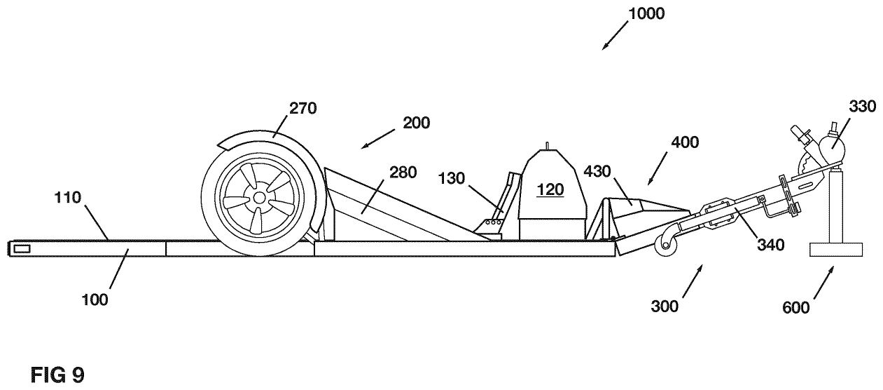

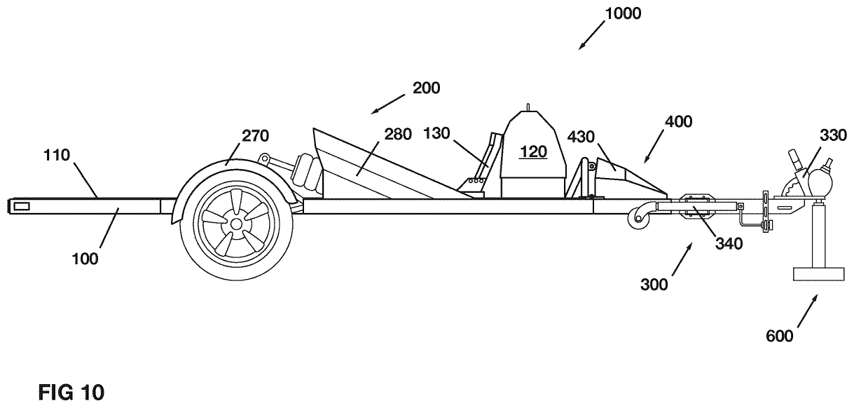

FIGS. 7-10 present the single carrier variant and dual carrier variant in plan in FIGS. 7 and 8, and the single carrier variant in lowered and raised positions in FIGS. 9 and 10. The chassis 100 and drawbar assembly 300 are pivotally connected which allows chassis 100 to be lowered to the lowered position in which the drawbar assembly 300, and more specifically tow hitch 330, to remain connected to (a vehicle (not shown), or as depicted to a stand 600.

FIGS. 11 and 12 depict one of the wheel-suspension assemblies 200 of the trailer 1000, where fitted to the chassis 100, with the chassis 100 in a lowered position in FIG. 11, and with the chassis 100 in a raised position in FIG. 12. The wheel guard 270 and chassis airbag cowling 280, apparent in FIGS. 1-10 are disassembled from the wheel-suspension assembly 200 depicted in FIGS. 11 and 12 to provide a clearer view of other components of the wheel-suspension assembly 200.

Wheel-suspension assembly 200 comprises a chassis airbag assembly 210, a swingarm linkage 220 and a wheel assembly 230. The chassis airbag assembly 210 is pivotally attached to the chassis 100 at one end and at the opposing end pivotally attached to the swingarm linkage 220. The swingarm linkage 220 is pivotally attached to the chassis 100. The wheel assembly 230 is mounted to the swingarm linkage 220.

The chassis airbag assembly 210 comprises a chassis airbag 214 which is retained by retaining plates 213, 215 matching the profile of the chassis airbag 214. Chassis airbag 214 is of triple bellows construction as depicted.

The chassis airbag assembly 210 is pivotally attached to the chassis 100 via a bushing 211 located at one end of the chassis airbag assembly 200. The bushing 211 is conveniently shoulder bolted between two tubular sections 102 of the chassis 100. The bushing 211 is connected to a hydraulic strut 212 which abuts the retailing plates 213. A rod 216 of the hydraulic strut 212 passes through the airbag 214 and retaining plates 213, 215, and is located and received in a receiver 217. Receiver 217 terminates in a bushing 218 which is pivotally attached to the swingarm linkage 220, and more specifically shoulder bolted to mounting bracket 225 at the junction of linkages 222, 223.

Swingarm linkage 220 comprises three linkages 221, 222, 223 fabricated to each other at their respective ends to form junctions where adjacent pairs of the linkages 221-223 are attached to each other. Linkages 221-223 thus present a triangular form. Respective junctions of the linkages 221-223 are locations of spaced apart attachments of the swingarm linkage 220 to the chassis 100, chassis airbag assembly 210 and wheel assembly 230. This arrangement provides leverage for the chassis airbag assemblies 210 to act on the wheel assemblies 230 relative to the chassis 100 through the swingarm linkages 220.

The triangular form of the swingarm linkage 220 approximates a right-angled triangle, and moreover approximates an isosceles right-angled. A triangular form used for the swingarm linkage 220 has the advantage of balancing a compact and lightweight as well as being robust in construction.

At a junction of linkages 221, 222 of swingarm linkage 220 where attached to chassis 100 there is located a bushing 224 fabricated as part of the swingarm linkage 220 which permits the swingarm linkage 220 to be pivotally attached to the chassis 100 in a similar manner the swingarm linkage 220 is pivotally attached to the chassis airbag assembly 210.

Mounting bracket 225 is fabricated as part of the swingarm linkage 210 at the junction of linkages 222, 223 adjacent to attachment to chassis airbag assembly 210. Mounting bracket 225 receives connecting rod 216 of the chassis airbag assembly 210, and acts to permit the connecting rod 216 to be shoulder bolted to the swingarm linkage 220.

A boss 226 is attached to the swingarm linkage 220 at the remaining junction of linkages 221, 223 adjacent the wheel assembly 230. Boss 226 is used for mounting the wheel assembly 230 on swingarm linkage 220. Between the wheel assembly 230 and swingarm linkage 220 there is fitted a flange 227 for mounting the wheel guard 270.

The wheel assembly 230 comprises a stub axle 240, upon which is mounted a wheel 250 fitted with a tyre 260. The stub axle 240 is attached to the swingarm linkage 220, or more accurately rotatably mounted to the swingarm linkage 220 by being fitted inside boss 226 of the swingarm linkage 230.

As is evident from reviewing FIGS. 11 and 12, the geometry of the wheel-suspension assembly 200 is such that inflation and deflation of chassis airbag 214 extends or contracts the length of the chassis airbag assembly 210. The effect of inflation or deflation of the chassis airbag 214 is that the chassis airbag assembly 210 acts upon the swingarm linkage 220 so that swingarm linkage 220 rotates downwardly or upwardly in relation to the chassis 100. The wheel assembly 230 relative to the chassis 100 transcribes a minor arc that is vertically oriented, and thus the chassis 100 is raised or lowered according to inflation or deflation of chassis airbags 214—in corporation with inflation and deflation of drawbar airbag 424 as described below in further detail.

When the chassis airbag 214 is deflated, the chassis 100 rests upon a ground surface in common with tyres 260, representing the trailer 1000 in a lowered position. Chassis 100 is preferably fitted with a skid plates (not shown) or similar to avoid wearing the chassis 100 when in the lowered position. As the chassis airbags 214 are inflated, the chassis airbag assemblies 210 extend and act on the swingarm linkage 220 to rotate the swingarm linkage 220 downwardly so that the chassis 100 lifts relative to the wheel assemblies 230. As the chassis airbags 214 become fully inflated, the stub axles 240 and centre of the wheels 250 become approximately level with the chassis 100, representing the chassis 1000 in a raised position at operative travel height.

The chassis airbag assemblies 210 and chassis airbags 214 in particular provide a suspension function to the trailer 1000 when in the raised position for travel. Chassis airbags 214 act to absorb irregularities in a road surface and thus minimise stress on components of the trailer 1000, and also reduce forces acting on the carried load of the trailer 1000. The hydraulic strut 212 supplements the suspension function of the chassis airbags 214, and accordingly both the chassis airbags 214 and struts 212 reduce transmission of road surface impacts from the wheel-suspension assemblies 200 to the chassis 100.

FIGS. 13 and 14 depict the drawbar assembly 300, and drawbar airbag assembly 400 in further detail, as well as the locking assemblies 150. As with FIGS. 11 and 12, the tray 110 is not shown, and neither is component box 120. The chassis 100 is depicted in the raised position.

The drawbar assembly 300 comprises a fabricated pattern of members, preferably of steel tubing of square profile as depicted, as with chassis 100.

The particular configuration of the drawbar assembly 300 comprises a leading member 310 to which is mounted the tow hitch 330 and jockey wheel assembly 340 described above. The leading member 310 is attached to two side members 312, which extend from the leading member 310 at an angle, and a central member 314. Together these members 310-314 form a trident-like formation, which is terminated by a terminal member 316 which spans members 312 and 314.

Chassis 100 and drawbar assembly 300 are hinged together collectively by a hinge 320 comprising hinging elements 322 which are alternatively affixed to chassis terminal member 102 and drawbar terminal member 316. Hinging elements 322 each comprise a small plate rolled back on itself at one end to form a b-shaped profile. The hinging elements 322 are aligned so that when the chassis terminal member 102 and drawbar terminal member 316 are collocated a securing pin (not shown) can be passed though the length of aligned hinging elements 322. This completes hinge 320 and creates a hinging pivotal connection between the chassis 100 and the drawbar assembly 300. Various alternative mechanisms can be used as required in place of hinge 320.

FIGS. 13 and 14 depict the drawbar airbag assembly 400 in its extended position, and the chassis 100 in its raised position. Construction of the drawbar airbag assemblies 400 is similar to that of chassis airbag assemblies 210. The drawbar airbag assembly 400 comprise a drawbar airbag 424 which is retained by retaining plates 423, 425 which match the profile of drawbar airbag 424. Drawbar airbag 424 is of double bellows construction as depicted.

Drawbar airbag assembly 400 at one end is pivotally attached to the drawbar assembly 300 via bushing 421 by shoulder bolting to mounting bracket 311. Bushing 421 is connected to hydraulic strut 422. Retaining plates 423 abut hydraulic strut 422. Strut 422 has a rod 426 that extends through airbag 424 and retaining plates 423, 425 and connects to bushing 427 at the other end of drawbar airbag assembly 400. The bushing 427 is retained by shoulder bolting to mounting bracket 416 in mounting plate 414 attached to U-shaped tubular section 412 mounted on the chassis terminal member 102.

FIGS. 13 and 14 both depict the chassis 100 in the raised position, with the drawbar terminal member 316 abutting the chassis terminal member 102. The chassis 100 has mounted therein a pair of spaced apart locking assemblies 150.

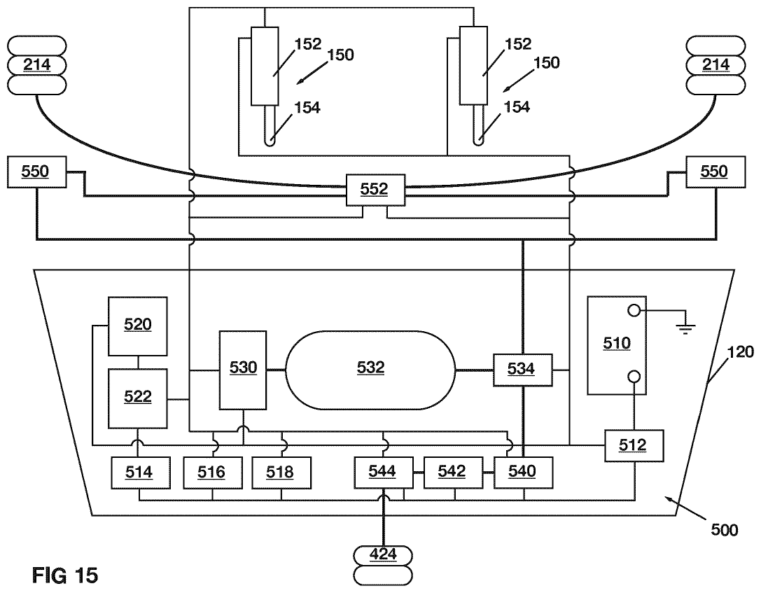

The locking assemblies 150 comprise locking pin actuators 152 having locking pins 154 that can be extended and retracted as required under control of control system 500 described below in further detail in connection with FIG. 15.

The locking assemblies 150 are mounted more specifically on longitudinally-oriented tubular members 102 of the chassis adjacent the drawbar assembly 300, and oriented so that can be locking pins 154 can be extended though the chassis terminal member 102 and the drawbar terminal member 316 as depicted in FIG. 13. The locking pins 154 are retracted as depicted in FIG. 14 prior to lowering the chassis 100 to its lowered position, which permits the drawbar assembly 300 to pivot relative to the chassis 100. This is achieved through a suitably located formation of holes 156, 318 in walls of the chassis terminal member 102 and the drawbar terminal member 316, which become aligned when the chassis 100 is in the raised position.

Both these members have 102, 316 have holes 156, 318 formed thereon to accept locking pins 154 when the chassis 100 is in the raised position and the holes 156, 318 aligned to permit locking. Should there be any malfunction connected with operation of the chassis airbag assemblies 210 or drawbar airbag assemblies 400, the chassis 100 remains in its raised position. The locking assemblies 150 and associated control system 500 are designed to ensure that in the event of a loss of power from the control system 500, the locking pins 154 remain in an extended position through the chassis 100 and drawbar assembly 300 as depicted in FIG. 13.

FIG. 15 depicts in schematic form control system 500 of the trailer 1000, which as depicted is principally housed within the component box 120. Control system 500 permits an operator to control the trailer 1000. Specifically, control system 500 permits lowering and raising the trailer 1000 as required by engaging chassis airbags 214, and drawbar airbag 424. Control system 500 also permits engaging and disengaging locking pins 152 when the trailer 1000 is in a raised position. This action is performed as a safety measure to ensure that the trailer 1000 remains stable and in a raised position in the unlikely event of malfunction affecting the airbags 214, 424.

Control system 500 is electro-pneumatic in nature, and may be characterised as comprising electrical circuits, and pneumatic circuits actuated by the electrical circuits. As a matter of convenience and for ease of understanding, lighter weight lines represent electrical connections, either 12V power connections or control communications connections, while heavier weight lines represent pneumatic connections.

Battery 510 is a conventional 12V lead-acid has its negative terminal grounded to the chassis 100. Typically, the battery 510 is charged during use through power via a trailer adapter from a vehicle (not shown) in the usual manner. Battery 510 has its positive terminal connected to a 20A fuse 512 that connects to a power switch 514, an actuating switch 516 and warning lights 518.

Power from battery 510 is also supplied via fuse 512 through a relay 520 to a control module 522. Relay 520 preferably comprises multiple discrete relays connected in concert with control module 522 via a wiring harness, as described below.

Various other components depicted receive 12V power vis fuse 512 and control signals via control module 522.

Power from battery 510 is for example supplied to a compressor 530, which generates pneumatic pressure supplied to an air tank 532. Air tank 532 in turn supplies ball valve 534, which is also electrically connected through fuse 512. Air tank 532 for safety reasons is typically fitted with a pressure gauge (not shown) and an on-off pressure valve (not shown).

Ball valve 534 balances pressure between the chassis airbags 214 at the rear trailing end of the trailer 1000 and the drawbar airbag 424 at the front leading end of the trailer 1000.

As regards the drawbar airbag 424, ball valve 534 supplies pneumatic pressure from the air tank 532 via a one-way valve 540. One-way valve 540 in turn connects to a regulator pressure valve 542, which in turn connects to a pressure relief valve 544. The pressure relief valve 544 connects directly to the drawbar airbag 424.

As regards the chassis airbags 214, ball valve 534 supplies pneumatic pressure to level-ride sensors 550, which are mounted on the chassis 100 at near lateral sides of the trailer 1000 and near the respective chassis airbags 214. The level-ride sensors 550 supply pneumatic pressure as input to pressure valve 552.

Pneumatic pressure from the level-ride sensors 550 is modulated by the orientation of the level-ride sensors 550. The level-ride sensors 550 on each lateral side of the trailer 1000 are designed and positioned so that if the trailer 1000 is lower on one lateral side than the opposing lateral side then a greater pneumatic pressure is delivered from the level-ride sensor 550 on that one lateral side, and conversely a lesser pneumatic pressure is delivered from the level-ride sensor 550 on the opposing lateral side. Imbalances in ride height are accordingly compensated.

Pressure relief valve 552 receives pneumatic pressure supplied by the level-ride sensors 550, and separately supplies pneumatic pressure to respective chassis airbags 214 installed at opposed lateral sides of the trailer as part of the greater wheel-suspension assemblies 200. As outlined above, level-ride sensors 550 modulate the pressure valve 552 to supply a suitable level of pressure and thus inflation to the respective chassis airbags 214 to maintain a level height in the raised position of the trailer 1000.

Control module 522 controls operation of the pressure relief valve 544 for the drawbar airbag 424, as well as for the pressure relief valve 552 for the chassis airbags 214. Control module 522 activates the respective pressure relief valves 544, 552 to lower the chassis 100 to the lowered position. Ball valve 534 co-ordinates inflation of the drawbar airbag 424, and the chassis airbags 214 in cooperation with level-ride sensors 550 to raise the chassis 100 to the raised position for travel.

Power switch 514 when off disconnects 12V power to other components, and when on connects 12V power to the actuating switch 516, warning lights 518, relay block 520, control module 522, compressor 530, ball valve 534, one-way valve 540, regulator pressure valve 542, and pressure relief valves 544, 552, locking assemblies 150.

The control system 500 operates as follows to raise and lower the trailer 1000, and ensure operation of the locking pins 152.

Power switch 514 switches on electrical power from the battery 510 to the control module 522 and other components of the control system 500 such as compressor 530.

Actuating switch 516 is preferably a rocker switch that raises and lowers the trailer 1000 by coordinating inflation and deflation of the airbags 610, 620 as described above.

Warning light 518 is a lamp that becomes active to indicate visually that the locking pins 152 are disengaged when the chassis 100 is in the raised position.

The foregoing description concerns a preferred embodiment only. As will be appreciated many modifications or alternatives may be made without departing from the present invention.

1. A height-adjustable trailer comprising:
a chassis;
a drawbar assembly pivotally attached to the chassis;
wheel-suspension assemblies mounted to the chassis at lateral opposing sides of the trailer, each of the wheel-suspension assemblies comprising a chassis airbag assembly, a swingarm linkage, and a wheel assembly, wherein the wheel assembly is mounted on the swingarm linkage, the swingarm linkage is pivotally attached to the chassis, and the chassis airbag assembly is pivotally attached at one end to the chassis and at the other end the chassis airbag assembly is pivotally attached to the swingarm linkage, and each of the chassis airbag assemblies comprise a chassis airbag and a hydraulic strut extending through the chassis airbag;
a drawbar airbag assembly attached to the chassis and the drawbar assembly;
a control system pneumatically connected to the drawbar airbag assembly and the chassis airbag assemblies and configured to extend the chassis airbag assemblies and the drawbar airbag assembly thereby to raise the chassis relative to the wheel-suspension assemblies to an operative travel height.

2. The height-adjustable trailer of claim 1, wherein each of the swingarm linkages is triangular in form, and is pivotally connected to the chassis and the chassis airbag assembly at different spaced apart junctions of the swingarm linkage.

3. The height-adjustable trailer of claim 2, wherein the wheel assembly is mounted to the swingarm linkage at a further different spaced apart junction of the swingarm linkage.

4. The height-adjustable trailer of claim 2, wherein each of the swingarm linkages comprises three linkages of elongate form connected together at the spaced apart junctions of the swingarm linkage.

5. The height-adjustable trailer of claim 4, wherein the chassis airbag assembly is directly pivotally connected to the chassis at a location spaced apart from the junction of the swingarm linkage which is directly pivotally attached to the chassis.

6. The height-adjustable trailer of claim 5, wherein the drawbar airbag assembly comprising a drawbar airbag and a hydraulic strut extending through the drawbar airbag.

7. The height-adjustable trailer of claim 6, further comprising at least one pressure relief valve associated with the chassis airbag assemblies and drawbar airbag assembly and activated by the control system to lower the chassis to a lowered position.

8. The height-adjustable trailer of claim 7, further comprising level-ride sensors associated with respective chassis airbag assemblies.

9. The height-adjustable trailer of claim 1, further comprising one or more locking assemblies comprising locking pin actuators and locking pins actuated by the locking pin actuators, the control system being electrically connected to the locking assemblies wherein when the trailer is in the raised position the locking pins can be retractably extended by the locking pin actuators though adjacent members of the chassis and the drawbar assembly to retain the trailer in the raised position in the event of failure of the drawbar airbag assembly or chassis airbag assemblies.

10. The height-adjustable trailer of claim 9, wherein the locking pin actuators are configured so that the locking pins remain in an extended position in the absence of electrical power to the locking pin actuators from the control system.

11. The height-adjustable trailer of claim 10, wherein the locking assemblies comprise a pair of locking assemblies positioned equidistant from lateral sides of the chassis.

12. The height-adjustable of claim 3, wherein each of the swingarm linkages comprises three linkages of elongate form connected together at the spaced apart junctions of the swingarm linkage.
